(19) United States
(12) Patent Application Publication
(10) Pub. No.: US 2025/0150880 A1
(43) Pub. Date: May 8, 2025

(54) METHOD AND APPARATUS FOR CELL SELECTION IN COMMUNICATION SYSTEM

(71) Applicant: ELECTRONICS AND TELECOMMUNICATIONS RESEARCH INSTITUTE, Daejeon (KR)

(72) Inventor: Hee Wook KIM, Daejeon (KR)

(73) Assignee: ELECTRONICS AND TELECOMMUNICATIONS RESEARCH INSTITUTE, Daejeon (KR)

(21) Appl. No.: 18/934,230

(22) Filed: Oct. 31, 2024

(30) Foreign Application Priority Data
Nov. 3, 2023 (KR) 10-2023-0151001
Oct. 10, 2024 (KR) 10-2024-0137873

(51) Int. Cl. H04W 24/10; H04W 64/00; H04W 84/06

(52) U.S. Cl. CPC H04W 24/10; H04W 64/00; H04W 84/06

(57) ABSTRACT

A method of a terminal may comprise: obtaining information on a dedicated service area of a non-terrestrial base station from the non-terrestrial base station; receiving neighboring cell information from the non-terrestrial base station; identifying a measurement target neighboring cell based on the neighboring cell information; and determining whether to initiate cell measurement on the measurement target neighboring cell based on the information on the dedicated service area.

### CROSS-REFERENCE TO RELATED APPLICATIONS

This application claims priority to Korean Patent Applications No. 10-2023-0151001, filed on Nov. 3, 2023, and No. 10-2024-0137873, filed on Oct. 10, 2024, with the Korean Intellectual Property Office (KIPO), the entire contents of which are hereby incorporated by reference.

### BACKGROUND

### 1. Technical Field

The present disclosure relates to a cell selection technique in a communication system, and more particularly, to a cell selection technique in a communications system, which allows a terminal within a service area of a non-terrestrial cell to avoid unnecessary measurements on terrestrial cells.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such communication networks may be classified as terrestrial networks, as they provide communication services to terminals located in terrestrial locations. Recently, the demand for communication services has been increasing not only for terrestrial locations but also for non-terrestrial locations, such as unmanned aerial vehicles and satellites. To address this, the 3GPP is discussing technologies for non-terrestrial networks (NTNs). The cell size of a non-terrestrial network may be relatively larger compared to that of a terrestrial network. Accordingly, terrestrial cells may exist locally within a non-terrestrial cell. When the terrestrial and non-terrestrial cells coexist on the same or on different frequencies, a terminal may measure both the terrestrial and non-terrestrial cells for cell selection and reselection. In cases where the terminal is located within a non-terrestrial cell not adjacent to terrestrial cells, the terminal may repeatedly perform unnecessary cell measurements. As a result, the power consumption of the terminal may increase.

### SUMMARY

The present disclosure for resolving the above-described problems is directed to providing a method and an apparatus for cell selection in a communication system, which allow a terminal within a service area of a non-terrestrial cell to avoid unnecessary measurements on terrestrial cells.

A cell selection method in a communication system, according to a first exemplary embodiment of the present disclosure for achieving the above-described objective, may comprise: obtaining information on a dedicated service area of a non-terrestrial base station from the non-terrestrial base station; receiving neighboring cell information from the non-terrestrial base station; identifying a measurement target neighboring cell based on the neighboring cell information; and determining whether to initiate cell measurement on the measurement target neighboring cell based on the information on the dedicated service area.

The obtaining of the information on the dedicated service area may comprise: receiving a system information block (SIB) including the information on the dedicated service area of the non-terrestrial base station from the non-terrestrial base station; and obtaining the information on the dedicated service area of the non-terrestrial base station from the SIB.

The neighboring cell information may include identification information of neighboring cells and priority information of the neighboring cells, and the identifying of the measurement target neighboring cell may comprise: identifying a priority of a frequency used by the non-terrestrial base station; comparing the priority of the frequency used by the non-terrestrial base station with priorities of the neighboring cells indicated by the neighboring cell information; and identifying a neighboring cell using a frequency having a higher priority than the frequency used by the non-terrestrial base station as the measurement target neighboring cell.

The method may further comprise: when the neighboring cell information includes neighboring cell type information, obtaining cell type information of the measurement target neighboring cell from the neighboring cell type information, wherein when the obtained cell type information of the measurement target neighboring cell indicates a terrestrial cell, the determining of whether to initiate cell measurement on the measurement target neighboring cell may be performed based on the information on the dedicated service area.

The determining of whether to initiate cell measurement on the measurement target neighboring cell based on the information on the dedicated service area may comprise: identifying a location of the terminal; determining whether the terminal is within the dedicated service area based on the identified location; and in response to determining that the terminal is within the dedicated service area, not initiating cell measurement on the measurement target neighboring cell.

The determining of whether to initiate cell measurement on the measurement target neighboring cell based on the information on the dedicated service area may comprise: identifying a location of the terminal; determining whether the terminal is within the dedicated service area based on the identified location; in response to determining that the terminal is outside the dedicated service area, identifying information on a service area of the measurement target neighboring cell; and determining whether to initiate cell measurement based on the location of the terminal and the information on the service area of the measurement target neighboring cell.

The identifying of the information on the service area of the measurement target neighboring cell may comprise: receiving a system information block (SIB) including the information on the service area of the measurement target neighboring cell from the non-terrestrial base station; and identifying the information on the service area of the measurement target neighboring cell from the SIB.

The identifying of the information on the service area of the measurement target neighboring cell may comprise: searching for information on the measurement target neighboring cell from the neighboring cell information; and identifying the information on the service area of the measurement target neighboring cell from the information on the measurement target neighboring cell.

The determining of whether to initiate cell measurement based on the location of the terminal and the information on the service area of the measurement target neighboring cell may comprise: determining whether the terminal is within the service area of the measurement target neighboring cell based on the location of the terminal; and in response to determining that the terminal is within the service area of the measurement target neighboring cell, initiating cell measurement on the measurement target neighboring cell.

A cell selection method in a communication system, according to a second exemplary embodiment of the present disclosure for achieving the above-described objective, may comprise: transmitting information on a dedicated service area of the non-terrestrial base station to a terminal; transmitting neighboring cell information on neighboring cells to the terminal; and receiving, from the terminal, a measurement result of measurement on a measurement target neighboring cell based on the information on the dedicated service area and the neighboring cell information.

The non-terrestrial base station may transmit the information on the dedicated service area to the terminal through a system information block (SIB).

The information on the dedicated service area may include at least one of information on a center location of the dedicated service area, information on a radius of the dedicated service area, or information on a threshold altitude of the dedicated service area.

The neighboring cell information may include at least one of identification information of each of the neighboring cells, non-terrestrial cell indication information for each of the neighboring cells, terrestrial cell indication information for each of the neighboring cells, available area information for each of the neighboring cells, frequency information for each of the neighboring cells, operator information for each of the neighboring cells, or priority information for each of the neighboring cells.

A terminal in a communication system, according to a third exemplary embodiment of the present disclosure for achieving the above-described objective, may comprise: at least one processor, wherein the at least one processor causes the terminal to perform: obtaining information on a dedicated service area of a non-terrestrial base station from the non-terrestrial base station; receiving neighboring cell information from the non-terrestrial base station; identifying a measurement target neighboring cell based on the neighboring cell information; and determining whether to initiate cell measurement on the measurement target neighboring cell based on the information on the dedicated service area.

In the obtaining of the information on the dedicated service area, the at least one processor may cause the terminal to perform: receiving a system information block (SIB) including the information on the dedicated service area of the non-terrestrial base station from the non-terrestrial base station; and obtaining the information on the dedicated service area of the non-terrestrial base station from the SIB.

The neighboring cell information may include identification information of neighboring cells and priority information of the neighboring cells, and in the identifying of the measurement target neighboring cell, the at least one processor may cause the terminal to perform: identifying a priority of a frequency used by the non-terrestrial base station; comparing the priority of the frequency used by the non-terrestrial base station with priorities of the neighboring cells indicated by the neighboring cell information; and identifying a neighboring cell using a frequency having a higher priority than the frequency used by the non-terrestrial base station as the measurement target neighboring cell.

The neighboring cell information may include neighboring cell type information, and the at least one processor may cause the terminal to perform: obtaining cell type information of the measurement target neighboring cell from the neighboring cell type information, wherein when the obtained cell type information of the measurement target neighboring cell indicates a terrestrial cell, the determining of whether to initiate cell measurement on the measurement target neighboring cell may be performed based on the information on the dedicated service area.

In the determining of whether to initiate cell measurement on the measurement target neighboring cell based on the information on the dedicated service area, the at least one processor may cause the terminal to perform: identifying a location of the terminal; determining whether the terminal is within the dedicated service area based on the identified location; and in response to determining that the terminal is within the dedicated service area, not initiating cell measurement on the measurement target neighboring cell.

In the determining of whether to initiate cell measurement on the measurement target neighboring cell based on the information on the dedicated service area, the at least one processor may cause the terminal to perform: identifying a location of the terminal; determining whether the terminal is within the dedicated service area based on the identified location; in response to determining that the terminal is outside the dedicated service area, identifying information on a service area of the measurement target neighboring cell; and determining whether to initiate cell measurement based on the location of the terminal and the information on the service area of the measurement target neighboring cell.

In the determining of whether to initiate cell measurement based on the location of the terminal and the information on the service area of the measurement target neighboring cell, the at least one processor may cause the terminal to perform: determining whether the terminal is within the service area of the measurement target neighboring cell based on the location of the terminal; and in response to determining that the terminal is within the service area of the measurement target neighboring cell, initiating cell measurement on the measurement target neighboring cell.

According to the present disclosure, a non-terrestrial cell can provide information on its service area to a terminal. The terminal can receive information regarding the service area of the non-terrestrial cell, and if it is located within the non-terrestrial cell's service area, it may refrain from performing unnecessary measurements on terrestrial cells. By avoiding unnecessary measurements on terrestrial cells, the terminal can reduce power consumption.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of a coexistence state of a non-terrestrial cell and a terrestrial cell.

FIG. 5 is a conceptual diagram illustrating a second exemplary embodiment of a coexistence state of a non-terrestrial cell and a terrestrial cell.

FIG. 6 is a flowchart illustrating a first exemplary embodiment of a cell selection method in a communication system.

FIG. 7 is a flowchart illustrating a second exemplary embodiment of a cell selection method in a communication system.

FIG. 8 is a flowchart illustrating a third exemplary embodiment of a cell selection method in a communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

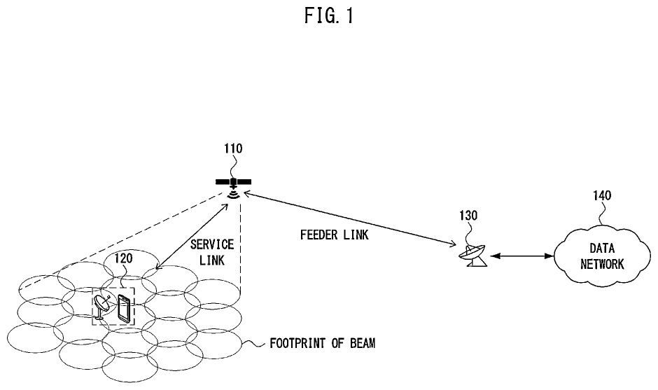

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

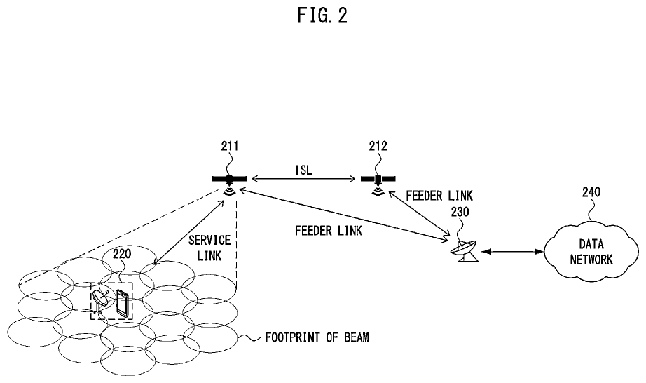

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

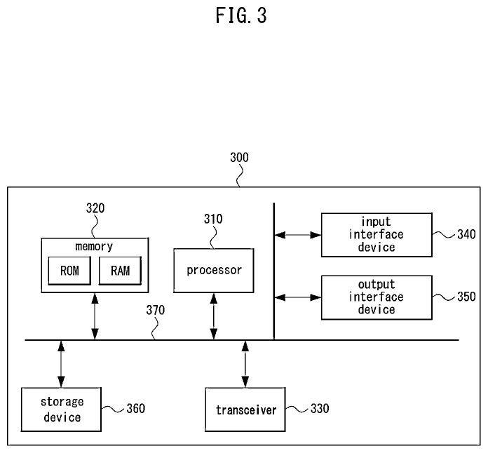

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D32’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel bandwidth | 30 MHz for band <6 GHz | |
| capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the minimum | | |
| elevation angle | | |
| Maximum round trip delay | Scenario A: 541.46 ms (service | Scenario C: (transparent |
| (RTD) | and feeder links) | payload: service and feeder |
| (only propagation delay) | Scenario B: 270.73 ms (only | links) |
| | service link) | −5.77 ms (altitude of 600 km) |
| | | −41.77 ms (altitude of 1,200 |
| | | km) |
| | | Scenario D: (regenerative |
| | | payload: only service link) |
| | | −12.89 ms (altitude of 600 km) |
| | | −20.89 ms (altitude of 1,200 |
| | | km) |
| Maximum delay variation | 16 ms | 4.44 ms (altitude of 600 km) |
| within a single beam | | 6.44 ms (altitude of 1,200 km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite altitude | 35,786 km | | 600 km | |
| Maximum RTD in a | 541.75 ms | 270.57 ms | 28.41 ms | 12.88 ms |
| radio interface between | (worst | | | |
| base station and UE | case) | | | |
| Minimum RTD in a | 477.14 ms | 238.57 ms | 8 ms | 4 ms |
| radio interface between | | | | |
| base station and UE | | | | |

Meanwhile, the communication system can provide services not only to terminals located in terrestrial locations but also to terminals in the air by utilizing airborne mobile platforms. The airborne platforms may include urban air mobility (UAM) vehicles, drones, aircrafts, and satellites. The terminals in the air may include handheld devices, fixed terminals, mobile platforms, and aeronautical earth stations in motion (A-ESIM). Additionally, the communication system can also provide services to both the terminals located in terrestrial locations and the terminals in the air through base stations located on the ground.

The airborne mobile platforms can form cells directed toward the ground, which may be classified as non-terrestrial cells. The base stations located on the ground can form cells directed toward the ground as well, which may be classified as terrestrial cells. With these diverse cell types, the communication system can provide services not only to the terminals located in terrestrial locations but also to the terminals in the air. The size of non-terrestrial cells may be relatively larger compared to that of terrestrial cells. Consequently, terrestrial cells may exist locally within a larger non-terrestrial cell.

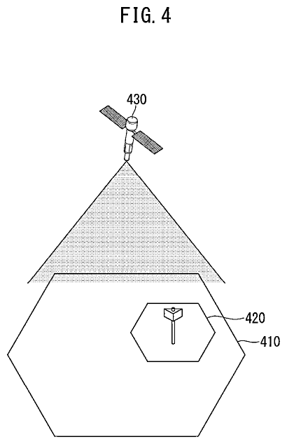

FIG. 4 is a conceptual diagram illustrating a first exemplary embodiment of a coexistence state of a non-terrestrial cell and a terrestrial cell.

Referring to FIG. 4, a terrestrial cell 410 may be located within a non-terrestrial cell 420 based on a satellite 430. Therefore, a terminal may access the terrestrial cell 410 while moving within the non-terrestrial cell 420.

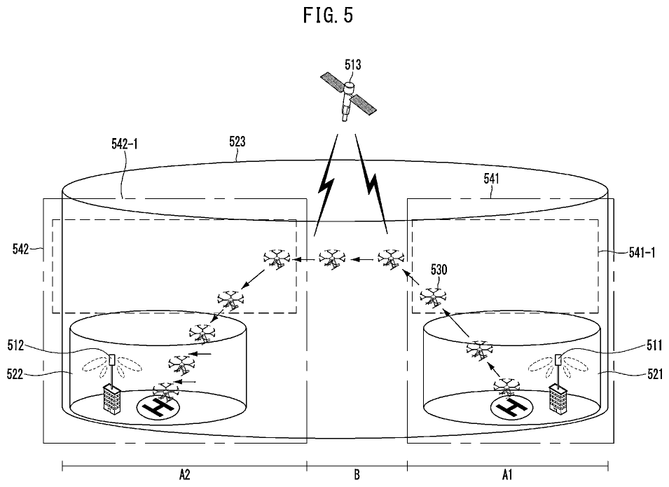

FIG. 5 is a conceptual diagram illustrating a second exemplary embodiment of a coexistence state of a non-terrestrial cell and a terrestrial cell.

Referring to FIG. 5, a first base station 511 located on the ground may form a first terrestrial cell 521. An available area A1 of the first terrestrial cell may be an area where a terminal 530 can use the first terrestrial cell 521. In addition, a second base station 512 located on the ground may form a second terrestrial cell 522. An available area A2 of the second terrestrial cell may be an area where the terminal 530 can use the second terrestrial cell 522.

A satellite 513 may form a non-terrestrial cell 523. A dedicated area B of the non-terrestrial cell may be an area located between the available area A1 of the first terrestrial cell and the available area A2 of the second terrestrial cell. The terminal 530 located in the dedicated area B of the non-terrestrial cell may not use the first terrestrial cell 521 and the second terrestrial cell 522, and may use the non-terrestrial cell 523.

A first scanning area 541 may be configured in relation to the available area A1 of the first terrestrial cell. In addition, a portion of the first scanning area 541 above a specific altitude may be referred to as a first sub-scanning area 541-1. A second scanning area 542 may be configured in relation to the available area A2 of the second terrestrial cell. In addition, a portion of the second scanning area 542 above a specific altitude may be referred to as a second sub-scanning area 542-1.

The terminal 530 may take off from a specific terrestrial location in the first scanning area 541 of the first terrestrial cell 521, fly for some time in the first scanning area 541 of the first terrestrial cell 521, and then enter and fly into the dedicated area B of the non-terrestrial cell. In this case, the terminal 530 may pass through the first sub-scanning area 541-1. Then, the terminal may enter the second scanning area 542 of the second terrestrial cell 522, fly for some time, and land at a specific location in the second scanning area 542. In this case, the terminal 530 may pass through the second sub-scanning area 542-1.

When the terminal 530 is located in the first scanning area 541 related to the available area A1 of the first terrestrial cell, the terminal may scan a frequency of the first terrestrial cell 521. In addition, when the terminal 530 is located in the second scanning area 542 related to the available area A2 of the second terrestrial cell, the terminal may scan a frequency of the second terrestrial cell 522.

The first sub-scanning area 541-1 may be a portion of the first scanning area 541. Accordingly, the terminal 530 may scan the frequency of the first terrestrial cell 521 when located in the first sub-scanning area 541-1. However, the first sub-scanning area 541-1 may be located at a certain distance or more from the first base station 511 and may be an area where communication services cannot be received from the first terrestrial cell 521.

Accordingly, even if the terminal 530 scans the frequency of the first terrestrial cell 521 in the first sub-scanning area 541-1, the terminal 530 may not be able to use the first terrestrial cell 521. For this reason, the operation of scanning the frequency of the first terrestrial cell 521 by the terminal 530 located in the first sub-scanning area 541-1 may be unnecessary. If the terminal 530 performs unnecessary operations in the first sub-scanning area 541-1 as described above, power may be wasted.

The second sub-scanning area 542-1 may be a portion of the second scanning area 542. Accordingly, the terminal 530 may scan the frequency of the second terrestrial cell 522 when located in the second sub-scanning area 542-1. However, the second sub-scanning area 542-1 may be located at a certain distance or more from the second base station 512 and may be an area where communication services cannot be received from the second terrestrial cell 522.

Accordingly, even if the terminal 530 scans the frequency of the second terrestrial cell 522 in the second sub-scanning area 542-1, the terminal 530 may not be able to use the second terrestrial cell 522. For this reason, the operation of scanning the frequency of the second terrestrial cell 522 by the terminal 530 located in the second sub-scanning area 542-1 may be unnecessary. If the terminal 530 performs unnecessary operations in the second sub-scanning area 542-1 as described above, power may be wasted.

In the above-described situation, the communication system may provide the terminal 530 with information on coverage areas of the terrestrial cells 521 and 522 using their center coordinates and on radii. In this case, the terminal 530 may perform unnecessary frequency scanning in the first sub-scanning area 541-1 and the second sub-scanning area 542-2. This may cause inefficient NTN-TN cell reselection for the terminal 530.

In other words, terrestrial cell(s) and non-terrestrial cell(s) may coexist at the same frequency or different frequencies. In such a case, the terminal may measure both terrestrial cell(s) and non-terrestrial cell(s) when performing neighboring cell measurements for cell selection and reselection. However, if the terminal is located in a non-terrestrial cell without adjacent terrestrial cells, or if the terminal has low mobility and does not move close to terrestrial cells, unnecessary terrestrial cell measurements may be repeated. Accordingly, the power consumption of the terminal may increase.

In order to reduce the power consumption of the terminal, the terminal may perform cell measurements at a location adjacent to terrestrial cells. The terminal within a non-terrestrial cell may perform cell measurements when the terminal reaches a specific measurement area while moving toward a service area of terrestrial cells. On the other hand, the terminal within a non-terrestrial cell may not perform cell measurements when the terminal does not reach the specific measurement area while moving toward the service area of the terrestrial cells.

In a cell selection method, a non-terrestrial cell base station may transmit information on available area(s) (i.e. available area information) of terrestrial cell(s) to the terminal. Then, the terminal may receive and obtain the information on available area(s) of terrestrial cell(s) from the non-terrestrial cell base station. Here, the information on available area(s) of terrestrial cell(s) may include at least one of identification information of an available area of each terrestrial cell, information on a center location of the available area of each terrestrial cell, information on a radius from the center location of the available area of each terrestrial cell, information on a threshold altitude from the center location of the available area of each terrestrial cell, and/or the like.

Here, the identification information of the available area of the terrestrial cell may be an identifier (ID) of the available area of the terrestrial cell, an index of the available area of the terrestrial cell, or the like. The threshold altitude may be a threshold altitude that is fixed regardless of the location. Alternatively, the threshold altitude may be an adjustable threshold altitude that decreases based on a distance from the center location of the available area of the terrestrial cell. The threshold altitude may be expressed as an altitude above sea level or an altitude above terrestrial level (AGL), may use a height as a unit, and may be a positive real number. In the present disclosure, the available area of the terrestrial cell may be referred to as a ‘service area’ of the terrestrial cell.

Accordingly, the terminal may recognize the identification information of the available area of each terrestrial cell, information on the center location of the available area of each terrestrial cell, information on the radius from the center location of the available area of each terrestrial cell, information on the threshold altitude from the center location of the available area of each terrestrial cell, and/or the like. In addition, the terminal may recognize the ID of the available area of each terrestrial cell, the index of the available area of each terrestrial cell, etc. from the received information on the available area(s) of the terrestrial cell(s).

In this case, the non-terrestrial cell base station may provide the information on the available area(s) of the terrestrial cell(s) to the terminal using a system information block (SIB). Alternatively, the non-terrestrial cell base station may provide the information on the available area(s) of the terrestrial cell(s) to the terminal using a dedicated channel.

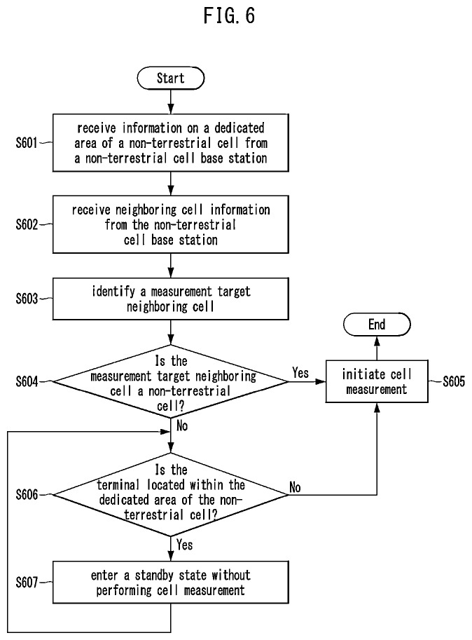

FIG. 6 is a flowchart illustrating a first exemplary embodiment of a cell selection method in a communication system.

Referring to FIG. 6, a non-terrestrial cell base station may provide information on a dedicated area of a non-terrestrial cell to a terminal. In this case, the information on the dedicated area of the non-terrestrial cell may include a center location, radius, threshold altitude, and/or other parameters of the dedicated area. The terminal may receive the information on the dedicated area of the non-terrestrial cell from the non-terrestrial cell base station (S601). Accordingly, the terminal may identify the center location, radius, threshold altitude, and/or other parameters of the dedicated area where the terminal can use the non-terrestrial cell.

The non-terrestrial cell base station may provide information on neighboring cell(s) of the non-terrestrial cell (i.e. neighboring cell information) to the terminal. The terminal may receive the neighboring cell information from the non-terrestrial cell base station (S602). The neighboring cell information may include at least one of cell identification information of each of neighboring cells, non-terrestrial cell indication information for each of the neighboring cells, terrestrial cell indication information for each of the neighboring cells, available area information for each of the neighboring cells, frequency information for each of the neighboring cells, operator information for each of the neighboring cells, or priority information for each of the neighboring cells.

The cell identification information of each of the neighboring cells may be a physical cell identifier (PCI). The non-terrestrial cell indication information for each of the neighboring cells may be non-terrestrial cell type indication information indicating that the neighboring cell is a non-terrestrial cell. The non-terrestrial cell type indication information may be a cell type indication bit indicating a non-terrestrial cell. The terrestrial cell indication information for each of the neighboring cells may be terrestrial cell type indication information indicating that the neighboring cell is a terrestrial cell. The cell type indication information may be a terrestrial cell type indication bit indicating a terrestrial cell.

The available area information for each of the neighboring cells may include at least one of identification information of an available area of each of the neighboring cells, information on a center location of the available area of each of the neighboring cells, information on a radius from the center of the available area of each of the neighboring cells, or information on a threshold altitude from the center of the available area of each of the neighboring cells.

The frequency information for each of the neighboring cells may be information indicating a frequency used by each of the neighboring cells. The operator information for each of the neighboring cells may indicate a public land mobile network (PLMN) ID for the corresponding neighboring cell. The priority information for each of the neighboring cells may be a priority value for a frequency of each of the neighboring cells.

Meanwhile, the terminal may identify a measurement target neighboring cell based on the priority information (S603). In other words, the terminal may identify a frequency having a higher priority than the non-terrestrial cell base station from the priority information. Then, the terminal may determine a neighboring cell having the identified frequency as the measurement target neighboring cell.

Then, the terminal may determine whether a cell type of the measurement target neighboring cell is a non-terrestrial cell (S604). In this case, if the terminal identifies non-terrestrial cell type indication information indicating that the measurement target neighboring cell is a non-terrestrial cell from the neighboring cell information, the terminal may determine the measurement target neighboring cell as a non-terrestrial cell. On the other hand, if the terminal identifies terrestrial cell type indication information indicating that the measurement target neighboring cell is a terrestrial cell from the neighboring cell information, the terminal may determine the measurement target neighboring cell as a terrestrial cell.

Alternatively, the terminal may determine the measurement target neighboring cell as a non-terrestrial cell if the terminal identifies frequency information for the measurement target neighboring cell from the neighboring cell information and the frequency of the measurement target neighboring cell is a frequency used by non-terrestrial cells. On the other hand, the terminal may determine the measurement target neighboring cell as a terrestrial cell if the terminal identifies frequency information for the measurement target neighboring cell from the neighboring cell information and the frequency of the measurement target neighboring cell is a frequency used by terrestrial cells.

Alternatively, the terminal may determine the measurement target neighboring cell as a non-terrestrial cell if the terminal identifies operator information for the measurement target neighboring cell from the neighboring cell information and an operator of the measurement target neighboring cell is an operator that operates non-terrestrial cells. On the other hand, the terminal may determine the measurement target neighboring cell as a terrestrial cell if the terminal identifies operator information for the measurement target neighboring cell from the neighboring cell information and an operator of the measurement target neighboring cell is an operator that operates terrestrial cells. Alternatively, the terminal may determine the measurement target neighboring cell as a non-terrestrial cell if the terminal cannot identify available area information for the measurement target neighboring cell from the neighboring cell information. On the other hand, the terminal may determine the measurement target neighboring cell as a terrestrial cell if the terminal can identify available area information for the measurement target neighboring cell from the neighboring cell information.

Meanwhile, the terminal may initiate cell measurement if the measurement target neighboring cell is a non-terrestrial cell (S605). However, if the measurement target neighboring cell is a terrestrial cell, the terminal may determine whether the terminal is located in the dedicated area of the non-terrestrial cell (S606). To this end, the terminal may determine a location of the terminal based on signals received from global positioning system (GPS) satellites. Thereafter, the terminal may determine whether the terminal is located above a threshold altitude from the center of the dedicated area of the non-terrestrial cell based on the information on the dedicated area of the non-terrestrial cell and the determined location of the terminal.

The terminal may not initiate terrestrial cell measurement and may enter a standby state if the terminal's location is determined to be above the threshold altitude from the center of the dedicated area of the non-terrestrial cell (S607). On the other hand, the terminal may initiate terrestrial cell measurement if the terminal's location is determined to be below the threshold altitude from the center of the dedicated area of the non-terrestrial cell (S605).

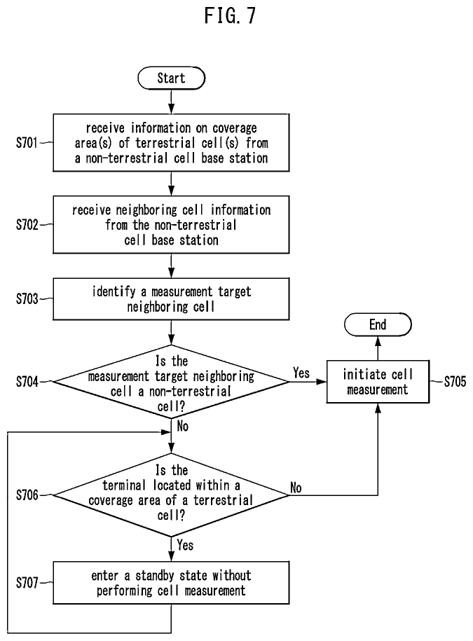

FIG. 7 is a flowchart illustrating a second exemplary embodiment of a cell selection method in a communication system.

Referring to FIG. 7, a non-terrestrial cell base station may provide information on coverage area(s) of terrestrial cell(s) to a terminal. In this case, the information on the coverage area(s) of terrestrial cell(s) may include a center location, radius, threshold altitude, and/or other parameters of the coverage area of each of the terrestrial cell(s). The terminal may receive the information on the coverage area(s) of the terrestrial cell(s) from the non-terrestrial cell base station (S701). Accordingly, the terminal may identify the center location, radius, threshold altitude, and/or other parameters of the coverage area of each of the terrestrial cell(s). The non-terrestrial cell base station may deliver the information on the coverage area(s) of the terrestrial cell(s) to the terminal through system information.

The non-terrestrial cell base station may provide information on neighboring cell(s) of the non-terrestrial cell (i.e. neighboring cell information) to the terminal. The terminal may receive the neighboring cell information from the non-terrestrial cell base station (S702). The neighboring cell information may include at least one of cell identification information of each of neighboring cells, non-terrestrial cell indication information for each of the neighboring cells, terrestrial cell indication information for each of the neighboring cells, available area information for each of the neighboring cells, frequency information for each of the neighboring cells, operator information for each of the neighboring cells, or priority information for each of the neighboring cells.

Here, the cell identification information of each of the neighboring cells may be a PCI. The non-terrestrial cell indication information for each of the neighboring cells may be non-terrestrial cell type indication information indicating that the neighboring cell is a non-terrestrial cell. The non-terrestrial cell type indication information may be a cell type indication bit indicating a non-terrestrial cell. The terrestrial cell indication information for each of the neighboring cells may be terrestrial cell type indication information indicating that the corresponding neighboring cell is a terrestrial cell. The cell type indication information may be a terrestrial cell type indication bit indicating a terrestrial cell.

The available area information for each of the neighboring cells may include at least one of identification information of an available area of each of the neighboring cells, information on a center location of the available area of each of the neighboring cells, information on a radius from the center of the available area of each of the neighboring cells, or information on a threshold altitude from the center of the available area of each of the neighboring cells.

The frequency information for each of the neighboring cells may be information indicating a frequency used by each of the neighboring cells. The operator information for each of the neighboring cells may indicate a PLMN ID for the corresponding neighboring cell. The priority information for each of the neighboring cells may be a priority value for a frequency of each of the neighboring cells.

Meanwhile, the terminal may identify a measurement target neighboring cell based on the priority information (S703). In other words, the terminal may identify a frequency having a higher priority than a frequency of the non-terrestrial cell base station from the priority information. Then, the terminal may determine a neighboring cell having the identified frequency as the measurement target neighboring cell.

Then, the terminal may determine whether a cell type of the measurement target neighboring cell is a non-terrestrial cell (S704). In this case, if the terminal identifies non-terrestrial cell type indication information indicating that the measurement target neighboring cell is a non-terrestrial cell from the neighboring cell information, the terminal may determine the measurement target neighboring cell as a non-terrestrial cell. On the other hand, if the terminal identifies terrestrial cell type indication information indicating that the measurement target neighboring cell is a terrestrial cell from the neighboring cell information, the terminal may determine the measurement target neighboring cell as a terrestrial cell.

Alternatively, the terminal may determine the measurement target neighboring cell as a non-terrestrial cell if the terminal identifies frequency information for the measurement target neighboring cell from the neighboring cell information and the frequency of the measurement target neighboring cell is a frequency used by non-terrestrial cells. On the other hand, the terminal may determine the measurement target neighboring cell as a terrestrial cell if the terminal identifies frequency information for the measurement target neighboring cell from the neighboring cell information and the frequency of the measurement target neighboring cell is a frequency used by terrestrial cells.

Alternatively, the terminal may determine the measurement target neighboring cell as a non-terrestrial cell if the terminal identifies operator information for the measurement target neighboring cell from the neighboring cell information and an operator of the measurement target neighboring cell is an operator that operates non-terrestrial cells. On the other hand, the terminal may determine the measurement target neighboring cell as a terrestrial cell if the terminal identifies operator information for the measurement target neighboring cell from the neighboring cell information and an operator of the measurement target neighboring cell is an operator that operates terrestrial cells. Alternatively, the terminal may determine the measurement target neighboring cell as a non-terrestrial cell if the terminal cannot identify available area information for the measurement target neighboring cell from the neighboring cell information. On the other hand, the terminal may determine the measurement target neighboring cell as a terrestrial cell if the terminal can identify available area information for the measurement target neighboring cell from the neighboring cell information.

Meanwhile, the terminal may initiate cell measurement if the measurement target neighboring cell is a non-terrestrial cell (S705). However, if the measurement target neighboring cell is a terrestrial cell, the terminal may determine whether the terminal is located in a coverage area of the terrestrial cell (S706). To this end, the terminal may determine a location of the terminal based on signals received from GPS satellites. Thereafter, the terminal may determine whether the terminal is located above a threshold altitude from a center of the coverage area of the terrestrial cell based on the information on the coverage area of the terrestrial cell and the determined location of the terminal.

The terminal may initiate terrestrial cell measurement if the location of the terminal is determined to be below the threshold altitude from the center of the coverage area of the terrestrial cell (S705). On the other hand, the terminal may not initiate terrestrial cell measurement and may enter a standby state if the location of the terminal is determined to be above the threshold altitude from the center of the coverage area of the terrestrial cell (S707).

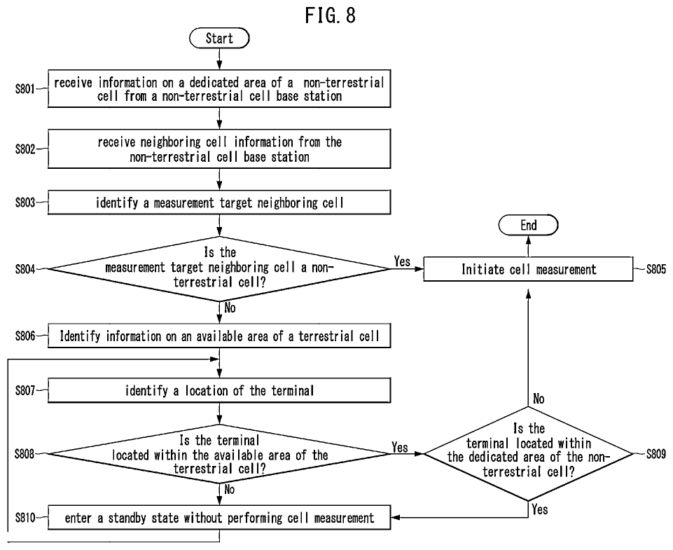

FIG. 8 is a flowchart illustrating a third exemplary embodiment of a cell selection method in a communication system.

Referring to FIG. 8, a non-terrestrial cell base station may provide information on a dedicated area of a non-terrestrial cell to a terminal. In this case, the information on the dedicated area of the non-terrestrial cell may include a center location, radius, threshold altitude, and/or other parameters of the dedicated area. The terminal may receive the information on the dedicated area of the non-terrestrial cell from the non-terrestrial cell base station (S801). Accordingly, the terminal may identify the center location, radius, threshold altitude, and/or other parameters of the dedicated area where the terminal can use the non-terrestrial cell.

The non-terrestrial cell base station may provide information on neighboring cell(s) of the non-terrestrial cell (i.e. neighboring cell information) to the terminal. The terminal may receive the neighboring cell information from the non-terrestrial cell base station (S802). The neighboring cell information may include at least one of cell identification information of each of neighboring cells, non-terrestrial cell indication information for each of the neighboring cells, terrestrial cell indication information for each of the neighboring cells, available area information for each of the neighboring cells, frequency information for each of the neighboring cells, operator information for each of the neighboring cells, or priority information for each of the neighboring cells.

The cell identification information of each of the neighboring cells may be a PCI. The non-terrestrial cell indication information for each of the neighboring cells may be non-terrestrial cell type indication information indicating that the neighboring cell is a non-terrestrial cell. The non-terrestrial cell type indication information may be a cell type indication bit indicating a non-terrestrial cell. The terrestrial cell indication information for each of the neighboring cells may be terrestrial cell type indication information indicating that the neighboring cell is a terrestrial cell. The cell type indication information may be a terrestrial cell type indication bit indicating a terrestrial cell.

The available area information for each of the neighboring cells may include at least one of identification information of an available area of each of the neighboring cells, information on a center location of the available area of each of the neighboring cells, information on a radius from the center of the available area of each of the neighboring cells, or information on a threshold altitude from the center of the available area of each of the neighboring cells.

The frequency information for each of the neighboring cells may be information indicating a frequency used by each of the neighboring cells. The operator information for each of the neighboring cells may indicate a PLMN ID for the corresponding neighboring cell. The priority information for each of the neighboring cells may be a priority value for a frequency of each of the neighboring cells.

Meanwhile, the terminal may identify a measurement target neighboring cell based on the priority information (S803). In other words, the terminal may identify a frequency having a higher priority than a frequency of the non-terrestrial cell base station from the priority information. Then, the terminal may determine a neighboring cell having the identified frequency as the measurement target neighboring cell.

Then, the terminal may determine whether a cell type of the measurement target neighboring cell is a non-terrestrial cell (S804). In this case, if the terminal identifies non-terrestrial cell type indication information indicating that the measurement target neighboring cell is a non-terrestrial cell from the neighboring cell information, the terminal may determine the measurement target neighboring cell as a non-terrestrial cell. On the other hand, if the terminal identifies terrestrial cell type indication information indicating that the measurement target neighboring cell is a terrestrial cell from the neighboring cell information, the terminal may determine the measurement target neighboring cell as a terrestrial cell.

Alternatively, the terminal may determine the measurement target neighboring cell as a non-terrestrial cell if the terminal identifies frequency information for the measurement target neighboring cell from the neighboring cell information and the frequency of the measurement target neighboring cell is a frequency used by non-terrestrial cells. On the other hand, the terminal may determine the measurement target neighboring cell as a terrestrial cell if the terminal identifies frequency information for the measurement target neighboring cell from the neighboring cell information and the frequency of the measurement target neighboring cell is a frequency used by terrestrial cells.

Alternatively, the terminal may determine the measurement target neighboring cell as a non-terrestrial cell if the terminal identifies operator information for the measurement target neighboring cell from the neighboring cell information and an operator of the measurement target neighboring cell is an operator that operates non-terrestrial cells. On the other hand, the terminal may determine the measurement target neighboring cell as a terrestrial cell if the terminal identifies operator information for the measurement target neighboring cell from the neighboring cell information and an operator of the measurement target neighboring cell is an operator that operates terrestrial cells. Alternatively, the terminal may determine the measurement target neighboring cell as a non-terrestrial cell if the terminal cannot identify available area information for the measurement target neighboring cell from the neighboring cell information. On the other hand, the terminal may determine the measurement target neighboring cell as a terrestrial cell if the terminal can identify available area information for the measurement target neighboring cell from the neighboring cell information.

Meanwhile, the terminal may initiate cell measurement if the measurement target neighboring cell is a non-terrestrial cell (S805). However, the terminal may identify information on an available area (i.e. available area information) of the measurement target neighboring cell if the measurement target neighboring cell is a terrestrial cell (S806). Further describing this in more detail, the terminal may identify information on a center location of the available area, a radius from the center of the available area, a threshold altitude from the center of the available area, and/or the like by identifying the available area information of the measurement target neighboring cell. In addition, the terminal may identify the ID of the available area, the index of the available area, and/or the like from the available area information of the measurement target neighboring cell.

Meanwhile, the terminal may determine a location of the terminal based on signals received from GPS satellites (S807). Thereafter, the terminal may determine whether the terminal is located within the radius from the center of the available area of the measurement target neighboring cell based on the available area information of the measurement target neighboring cell and the determined location of the terminal (S808).

If the location of the terminal is determined to be within the radius from the center of the available area of the measurement target neighboring cell, the terminal may determine whether the terminal is located within the dedicated area of the non-terrestrial cell (S809). In other words, the terminal may determine whether the terminal is located above the threshold altitude from the center of the dedicated area of the non-terrestrial cell based on the information on the dedicated area of the non-terrestrial cell and the identified location of the terminal.

If the location of the terminal is determined to be above the threshold altitude from the center of the dedicated area of the non-terrestrial cell, the terminal may not initiate terrestrial cell measurement and may enter a standby state (S810). On the terminal hand, if the location of the terminal is determined to be below the threshold altitude from the center of the dedicated area of the non-terrestrial cell, the terminal may determine whether the location of the terminal is below the threshold altitude of the terrestrial cell. The terminal may not initiate cell measurement and enter a standby state if the location of the terminal is determined to be above the threshold altitude of the terrestrial cell. On the other hand, the terminal may initiate cell measurement if the location of the terminal is determined to be below the threshold altitude of the terrestrial cell (S805).

Meanwhile, the terminal may perform cell measurement on the measurement target neighboring cell and transmit a result of the cell measurement to the non-terrestrial cell. Then, the non-terrestrial cell may receive the result of the cell measurement from the terminal and utilize it for a subsequent handover, etc.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
obtaining information on a dedicated service area of a non-terrestrial base station from the non-terrestrial base station;
receiving neighboring cell information from the non-terrestrial base station;
identifying a measurement target neighboring cell based on the neighboring cell information; and
determining whether to initiate cell measurement on the measurement target neighboring cell based on the information on the dedicated service area.

2. The method according to claim 1, wherein the obtaining of the information on the dedicated service area comprises:
receiving a system information block (SIB) including the information on the dedicated service area of the non-terrestrial base station from the non-terrestrial base station; and
obtaining the information on the dedicated service area of the non-terrestrial base station from the SIB.

3. The method according to claim 1, wherein the neighboring cell information includes identification information of neighboring cells and priority information of the neighboring cells, and the identifying of the measurement target neighboring cell comprises:
identifying a priority of a frequency used by the non-terrestrial base station;
comparing the priority of the frequency used by the non-terrestrial base station with priorities of the neighboring cells indicated by the neighboring cell information; and
identifying a neighboring cell using a frequency having a higher priority than the frequency used by the non-terrestrial base station as the measurement target neighboring cell.

4. The method according to claim 1, further comprising: when the neighboring cell information includes neighboring cell type information, obtaining cell type information of the measurement target neighboring cell from the neighboring cell type information,
wherein when the obtained cell type information of the measurement target neighboring cell indicates a terrestrial cell, the determining of whether to initiate cell measurement on the measurement target neighboring cell is performed based on the information on the dedicated service area.

5. The method according to claim 1, wherein the determining of whether to initiate cell measurement on the measurement target neighboring cell based on the information on the dedicated service area comprises:
identifying a location of the terminal;
determining whether the terminal is within the dedicated service area based on the identified location; and
in response to determining that the terminal is within the dedicated service area, not initiating cell measurement on the measurement target neighboring cell.

6. The method according to claim 1, wherein the determining of whether to initiate cell measurement on the measurement target neighboring cell based on the information on the dedicated service area comprises:
identifying a location of the terminal;
determining whether the terminal is within the dedicated service area based on the identified location;
in response to determining that the terminal is outside the dedicated service area, identifying information on a service area of the measurement target neighboring cell; and
determining whether to initiate cell measurement based on the location of the terminal and the information on the service area of the measurement target neighboring cell.

7. The method according to claim 6, wherein the identifying of the information on the service area of the measurement target neighboring cell comprises:
receiving a system information block (SIB) including the information on the service area of the measurement target neighboring cell from the non-terrestrial base station; and
identifying the information on the service area of the measurement target neighboring cell from the SIB.

8. The method according to claim 6, wherein the identifying of the information on the service area of the measurement target neighboring cell comprises:
searching for information on the measurement target neighboring cell from the neighboring cell information; and
identifying the information on the service area of the measurement target neighboring cell from the information on the measurement target neighboring cell.

9. The method according to claim 6, wherein the determining of whether to initiate cell measurement based on the location of the terminal and the information on the service area of the measurement target neighboring cell comprises:
determining whether the terminal is within the service area of the measurement target neighboring cell based on the location of the terminal; and
in response to determining that the terminal is within the service area of the measurement target neighboring cell, initiating cell measurement on the measurement target neighboring cell.

10. A method of a non-terrestrial base station, comprising:
transmitting information on a dedicated service area of the non-terrestrial base station to a terminal;
transmitting neighboring cell information on neighboring cells to the terminal; and
receiving, from the terminal, a measurement result of measurement on a measurement target neighboring cell based on the information on the dedicated service area and the neighboring cell information.

11. The method according to claim 10, wherein the non-terrestrial base station transmits the information on the dedicated service area to the terminal through a system information block (SIB).

12. The method according to claim 11, wherein the information on the dedicated service area includes at least one of information on a center location of the dedicated service area, information on a radius of the dedicated service area, or information on a threshold altitude of the dedicated service area.

13. The method according to claim 10, wherein the neighboring cell information includes at least one of identification information of each of the neighboring cells, non-terrestrial cell indication information for each of the neighboring cells, terrestrial cell indication information for each of the neighboring cells, available area information for each of the neighboring cells, frequency information for each of the neighboring cells, operator information for each of the neighboring cells, or priority information for each of the neighboring cells.

14. A terminal comprising at least one processor, wherein the at least one processor causes the terminal to perform:
obtaining information on a dedicated service area of a non-terrestrial base station from the non-terrestrial base station;
receiving neighboring cell information from the non-terrestrial base station;
identifying a measurement target neighboring cell based on the neighboring cell information; and
determining whether to initiate cell measurement on the measurement target neighboring cell based on the information on the dedicated service area.

15. The terminal according to claim 14, wherein in the obtaining of the information on the dedicated service area, the at least one processor causes the terminal to perform:
receiving a system information block (SIB) including the information on the dedicated service area of the non-terrestrial base station from the non-terrestrial base station; and
obtaining the information on the dedicated service area of the non-terrestrial base station from the SIB.

16. The terminal according to claim 14, wherein the neighboring cell information includes identification information of neighboring cells and priority information of the neighboring cells, and in the identifying of the measurement target neighboring cell, the at least one processor causes the terminal to perform:
identifying a priority of a frequency used by the non-terrestrial base station;
comparing the priority of the frequency used by the non-terrestrial base station with priorities of the neighboring cells indicated by the neighboring cell information; and
identifying a neighboring cell using a frequency having a higher priority than the frequency used by the non-terrestrial base station as the measurement target neighboring cell.

17. The terminal according to claim 14, wherein the neighboring cell information includes neighboring cell type information, and the at least one processor causes the terminal to perform: obtaining cell type information of the measurement target neighboring cell from the neighboring cell type information,
wherein when the obtained cell type information of the measurement target neighboring cell indicates a terrestrial cell, the determining of whether to initiate cell measurement on the measurement target neighboring cell is performed based on the information on the dedicated service area.

18. The terminal according to claim 14, wherein in the determining of whether to initiate cell measurement on the measurement target neighboring cell based on the information on the dedicated service area, the at least one processor causes the terminal to perform:
identifying a location of the terminal;
determining whether the terminal is within the dedicated service area based on the identified location; and
in response to determining that the terminal is within the dedicated service area, not initiating cell measurement on the measurement target neighboring cell.

19. The terminal according to claim 14, wherein in the determining of whether to initiate cell measurement on the measurement target neighboring cell based on the information on the dedicated service area, the at least one processor causes the terminal to perform:
identifying a location of the terminal;
determining whether the terminal is within the dedicated service area based on the identified location;
in response to determining that the terminal is outside the dedicated service area, identifying information on a service area of the measurement target neighboring cell; and
determining whether to initiate cell measurement based on the location of the terminal and the information on the service area of the measurement target neighboring cell.

20. The terminal according to claim 19, wherein in the determining of whether to initiate cell measurement based on the location of the terminal and the information on the service area of the measurement target neighboring cell, the at least one processor causes the terminal to perform:
determining whether the terminal is within the service area of the measurement target neighboring cell based on the location of the terminal; and
in response to determining that the terminal is within the service area of the measurement target neighboring cell, initiating cell measurement on the measurement target neighboring cell.
